(19) United States
(12) Patent Application Publication
(10) Pub. No.: US 2007/0079256 A1
(43) Pub. Date: Apr. 5, 2007

(54) Method, apparatus and program for outputting images

(75) Inventor: Jun Enomoto, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/606,953

(22) Filed: Dec. 1, 2006

(30) Foreign Application Priority Data
Jan. 12, 2005 (JP) 2005-348221

(51) Int. Cl. G06F 17/00; G06F 7/00; H04N 5/222; H04N 7/00

(52) U.S. Cl. 715/838; 707/100; 348/333.05; 348/552; 715/517; 715/526

(57) ABSTRACT

A card reader loads thumbnail image data from a memory card. Plural thumbnail images are arranged in a matrix, and displayed as an index image on an image selection screen. The thumbnail image to be printed is selected on the image selection screen. The card reader loads principal image data corresponding to the selected thumbnail image and its accompanying information from the memory card. An image processor applies various image processing, such as gradation correction, over the principal image data. A principal image is printed on a front surface of a photographic paper and the index image is printed on a rear surface of the same.

### BACKGROUND OF THE INVENTION

1. Field of the Invention

The present invention relates to image outputting method, apparatus and program, which are used for image printers and the like.

2. Description Related to the Prior Art

Digital still cameras are known, and record captured images as digital data in a recording medium such as a memory card. The images captured by the digital cameras are printed on photographic papers or displayed on a monitor of a personal computer. The digital image data is stored in an image file of a predetermined file format such as Exchangeable Image File Format (EXIF). The EXIF stores accompanying information of the captured image, which are shooting conditions, and shooting date and time, in addition to the image data.

EXIF image files store principal image data as the image data. The principal image data has a large number of recorded pixels, and is mainly used for printing. The EXIF image files also store thumbnail image data as the image data. The thumbnail image data has a smaller number of recorded pixels than the principal image data, and is used for, for example, image search. The number of recorded pixels for the thumbnail image data is determined to 160×120 pixels under Digital Camera Format (DCF) standard.

In addition, an index print is well known as disclosed in, for example, Japanese Patent Laid-Open Publication No. 2004-322526. The index print is an index image having plural images as sub-frames arranged in a matrix within a single frame recorded on a recording material such as the photographic paper. In order to produce the index image, principal image data is firstly read out from each image file and then reduced to become thumbnail image data. Plural thumbnail images are merged, and thereby producing the index image. The index print is given for free to, for example, customers who have ordered photo printing. The index print is used for organizing the photo prints and knowing chronological order of the same, besides used for searching the images to be printed.

Since the index image is produced by processing the principal image data, it has been a problem that it takes time to produce the index image. In addition, since the index print is produced separately from the photo prints, it results in additional costs.

### SUMMARY OF THE INVENTION

A primary object of the present invention is to provide image outputting method, apparatus and program capable of producing an index image at short times.

Another object of the present invention is to provide image outputting method, apparatus and program capable of producing the index image at low costs.

In order to achieve the above and other objects, an image outputting method according to the present invention includes the step of loading thumbnail image data from an image file that stores principal image data and the thumbnail image data as image data. The thumbnail image data has data size smaller than the principal image data. The method also includes the steps of producing an index image with the use of the thumbnail image data and outputting the index image. The index image has plural thumbnail images arranged in a matrix.

In the index image outputting step, it is preferable that the index image is displayed on a monitor. It is also preferable that one of the thumbnail images is selected from the index image displayed on the monitor, and the principal image data corresponding to the selected thumbnail image is loaded, and then a principal image reproduced from the principal image data is printed on a first surface of a recording material and the index image is printed on a second surface of the recording material.

An image outputting apparatus according to the present invention includes a thumbnail image loading device, an index image producing device and an index image outputting device. The thumbnail image loading device loads thumbnail image data from an image file that stores principal image data and the thumbnail image data as image data. The thumbnail image data has data size smaller than the principal image data. The index image producing device produces an index image that has plural thumbnail images arranged in a matrix with the use of the thumbnail image data. The index image outputting device outputs the index image.

The index image outputting device preferably includes a monitor. It is preferable that the index image outputting device further includes a selecting device, a principal image loading device and a printing device. The selecting device selects one of the thumbnail images from the index image displayed on the monitor. The principal image loading device loads the principal image data corresponding to the selected thumbnail image. The printing device prints a principal image reproduced from the principal image data on a first surface of a recording material and the index image on a second surface of the recording material.

An image outputting program according to the present invention directs an image outputting apparatus to execute the step of loading thumbnail image data from an image file that stores principal image data and the thumbnail image data as image data. The thumbnail image data has data size smaller than the principal image data. The program also directs the image outputting apparatus to execute the steps of producing an index image with the use of the thumbnail image data and outputting the index image. The index image has plural thumbnail images arranged in a matrix.

It is preferable that the index image outputting step further includes the steps of displaying the index image on a monitor, selecting one of the thumbnail images from the index image displayed on the monitor, loading the principal image data corresponding to the selected thumbnail image, and printing a principal image reproduced from the principal image data on a first surface of a recording material and the index image on a second surface of the recording material.

In a preferable embodiment of the present invention, the principal image and the index image are respectively printed on opposite surfaces of the recording material.

According to the present invention, the image file stores the principal image data and the thumbnail image data having the data size smaller than the principal image data, and the thumbnail image data is loaded from the image file. The loaded thumbnail image data is used to produce the index image in which plural thumbnail images are arranged in a matrix, and the index image is output. Owing to this, time taken for producing the index image can be shortened.

In addition, one of the thumbnail images is selected from the index image displayed on the monitor, and the principal image corresponding to the selected thumbnail image and the index image are respectively printed on the opposite surfaces of the recording material. Owing to this, costs for the recording materials can be saved, and thereby producing the index prints at low costs.

### BRIEF DESCRIPTION OF THE DRAWINGS

The above objects and advantages of the present invention will become more apparent from the following detailed description when read in connection with the accompanying drawings, in which:

FIG. 1 is a block diagram illustrating an electric structure of a printer to which the present invention is applied;

FIG. 2 is an explanatory view illustrating a structure of an image file;

FIG. 3 is an explanatory view illustrating a double-sided print; and

FIG. 4 is a flow chart illustrating a producing process of the double-sided print.

### DETAILED DESCRIPTION OF THE PREFERRED EMBODIMENTS

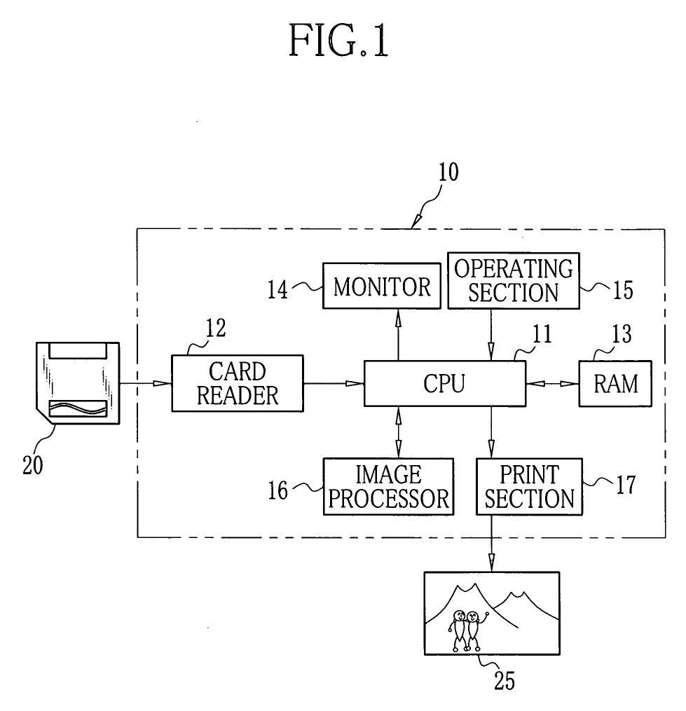

In FIG. 1, a printer 10 is, for example, a photo printer equipped in a print shop. A card reader 12, a RAM 13, a monitor 14, an operating section 15, an image processor 16 and a print section 17 are connected to a CPU 11. The CPU 11 takes overall control of each component in the printer 10.

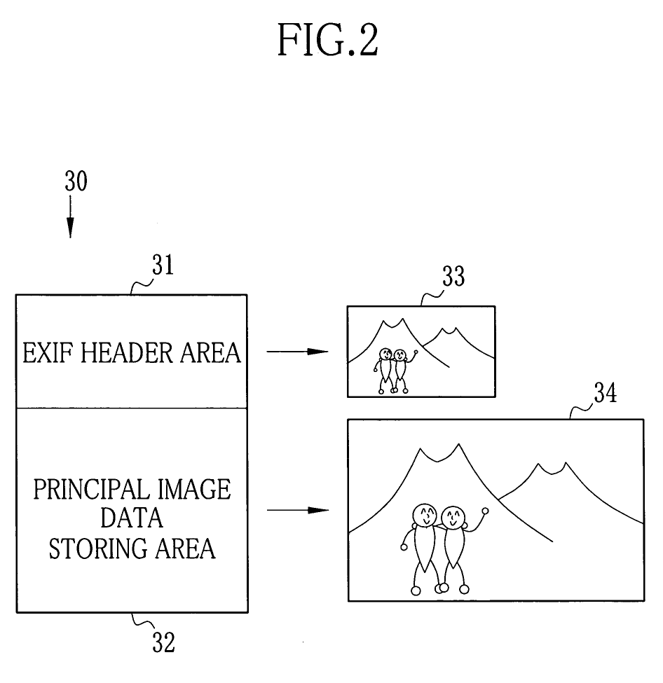

As shown in FIG. 2, an image file 30 is produced for every image frame, and image data is stored in the image file 30. The image file 30 is, for example, in EXIF format. The captured image data includes principal image data 34 and thumbnail image data (reduced image data) 33. The thumbnail image data 33 has a smaller number of pixels than the principal image data 34. The image file 30 has a principal image data storing area 32 and an EXIF header area (accompanying information storing area) 31. The principal image data storing area 32 stores the principal image data 34. The EXIF header area 31 stores the thumbnail image data 33 and accompanying information of the captured image, which are number of recorded pixels of the principal image data 34, shooting conditions, and shooting date and time.

A memory card 20 which is brought in by a customer is detachably connected to the card reader 12, and thumbnail image data 33 in all image files 30 is loaded from the memory card 20. The loaded thumbnail image data 33 is temporarily stored in the RAM 13. The RAM 13 is a work memory for the CPU 11 to execute various processing.

The monitor 14 displays an operation screen. The operation screen includes an image selection screen and a parameter designation screen. On the image selection screen, images to be printed and number of prints are designated. On the parameter designation screen, parameters for various image processing, such as gradation correction, are designated. On the image selection screen, for example, an index image having plural thumbnail images arranged in a matrix is displayed. The operating section 15 includes a key board and a mouse, and inputs a command to the CPU 11 through the operation screen on the monitor 14. An operator or the customer operates the operating section 15 to select thumbnail images corresponding to principal images to be printed and the number of prints while observing the image selection screen.

The card reader 12 loads principal image data 34 corresponding to the selected thumbnail image and its accompanying information from the memory card 20 and stores them in the RAM 13 temporarily. At this time, principal image data 34 of non-selected image is not loaded, and therefore the processing time for loading the data will not be too long.

The image processor 16 applies various image processing, such as gradation correction, tone correction, saturation correction and sharpness processing, over the principal image data 34 in the RAM 13. In addition, the image processor 16 reads out the thumbnail image data 33 from the RAM 13 and produces index image data. The index image data is produced by merging the thumbnail image data 33 such that plural thumbnail images are arranged in a matrix within a single frame. Since the thumbnail image data 33 having the data size smaller than the principal image data 34 is used for producing the index image, the processing time therefor can be reduced as compared to the conventional way where the index image is produced from the principal image data.

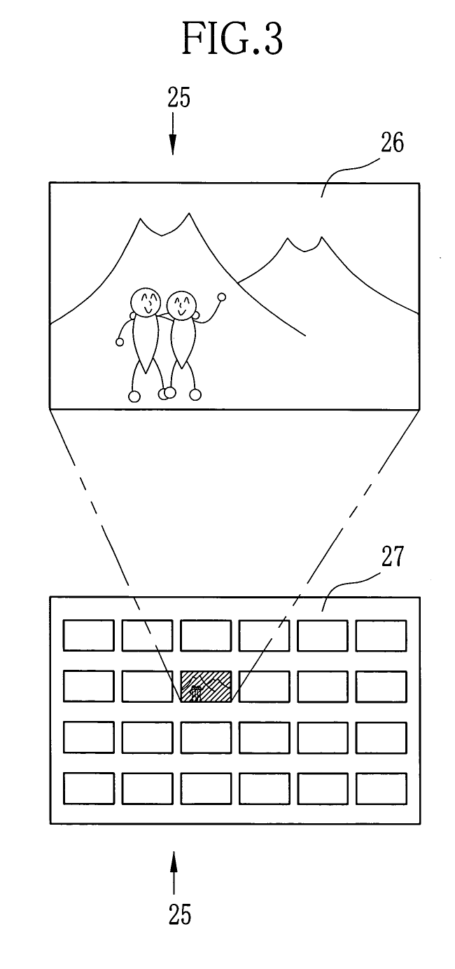

The image processor 16 then applies color conversion processing from BGR to YMC colors over the processed principal image data 34, and the index image data respectively in order to produce print data. The image processor 16 sends the print data to the print section 17. As shown in FIG. 3, images are recorded on a front surface 26 and a rear surface 27 of a recording material such as a photographic paper. This photographic paper has a photosensitive layer on both surfaces thereof.

The print section 17 has print stations above and below a path for the photographic paper, and prints a frame image produced from the principal image data 34 on the front surface 26 of a double-sided print 25 and the index image on the rear surface 27 of the same. The index image includes the frame image printed on the front surface 26. In this embodiment, the index image has 24 thumbnail images. It is preferable that the thumbnail images are arranged such that the thumbnail image corresponding to a principal image printed on the front surface 26 is arranged at a specific position, for example, at the center of the index image.

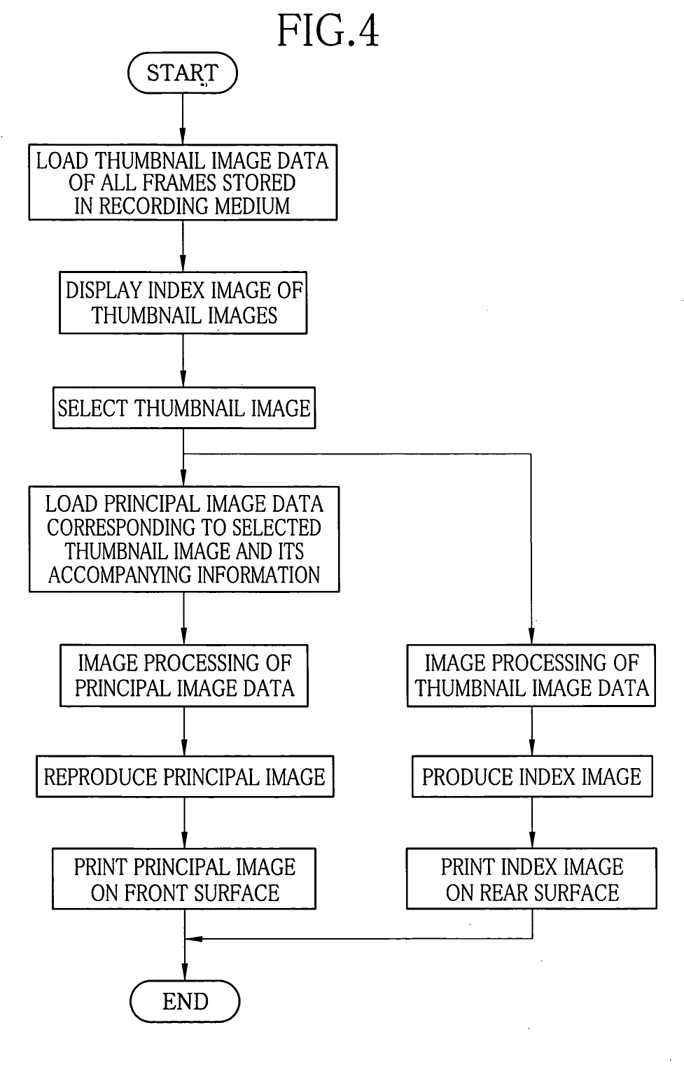

Hereinafter, a producing process of the double-sided print is explained with referring to a flow chart in FIG. 4. When the memory card 20 is set to the printer 10, the card reader 12 loads the thumbnail image data 33 from all of the image files 30. The thumbnail image data 33 is temporarily stored in the RAM 13, and at the same time, displayed as the index image on the image selection screen for designating the images to be printed.

While the image selection screen is observed on the monitor 14, the thumbnail images to be printed are selected by operating the operating section 15. The card reader 12 loads the principal image data 34 corresponding to the selected thumbnail image and its accompanying information from the memory card 20. The principal image data 34 is temporarily stored in the RAM 13, and at the same time, undergoes various image processing by the image processor 16.

The image processor 16 reads out the thumbnail image data 33 in the RAM 13 and merges them such that the plural thumbnail images are arranged in a matrix within a single frame, and thereby producing the index image data. Moreover, the image processor 16 applies color conversion processing from BGR to YMC colors over the processed principal image data 34, and the index image data respectively in order to produce the print data.

The print data is sent to the print section 17. Based on this print data, a frame image produced from the principal image data 34 is printed on the front surface 26 of the double-sided print 25 and the index image is printed on the rear surface 27 of the same. Owing to this, the double-sided print 25 can be printed in less processing time than ever before. The photographic paper is cut frame by frame after the print operation.

In the above embodiment, the printer 10 is explained as an example of the image outputting apparatus, however the present invention is not limited to this. The image outputting apparatus may be the monitor or any other apparatuses which output the index image in the form of electric signals.

The present invention is not limited to the photo printer, but applicable to ink-jet printers and thermal printers.

When the conventional photographic papers having the photosensitive layer on one side thereof are used, the principal image is optically printed on the photosensitive layer and the index image is printed on the other side by, for example, an ink-jet printer.

Various changes and modifications are possible in the present invention and may be understood to be within the present invention.

What is claimed is:

1. An image outputting method for outputting image data obtained by an image capturing device, comprising the steps of:
loading thumbnail image data from an image file storing, as said image data, principal image data and said thumbnail image data having data size smaller than said principal image data;
producing an index image having plural thumbnail images arranged with the use of said thumbnail image data; and
outputting said index image.

2. An image outputting method described in claim 1, wherein said index image outputting step includes the step of displaying said index image on a monitor.

3. An image outputting method described in claim 2, wherein said index image outputting step further including the steps of:
selecting one of said thumbnail images from said index image displayed on said monitor;
loading said principal image data corresponding to the selected thumbnail image; and
printing a principal image reproduced from said principal image data on a first surface of a recording material and said index image on a second surface of said recording material.

4. An image outputting method described in claim 3, wherein said image file is stored in a memory card, said memory card being detachably connected to said image capturing device.

5. An image outputting method described in claim 4, wherein said image file is in a predetermined file format having an accompanying information storing area for storing shooting conditions, and shooting date and time of said image.

6. An image outputting apparatus for outputting image data obtained by an image capturing device, comprising:
a thumbnail image loading device for loading thumbnail image data from an image file storing, as said image data, principal image data and said thumbnail image data having data size smaller than said principal image data;
an index image producing device for producing an index image having plural thumbnail images arranged with the use of said thumbnail image data; and
an index image outputting device for outputting said index image.

7. An image outputting apparatus described in claim 6, wherein said index image outputting device includes a monitor for displaying said index image.

8. An image outputting apparatus described in claim 7, wherein said index image outputting device further including:
a selecting device for selecting one of said thumbnail images from said index image displayed on said monitor;
a principal image loading device for loading said principal image data corresponding to the selected thumbnail image; and
a printing device for printing a principal image reproduced from said principal image data on a first surface of a recording material and said index image on a second surface of said recording material.

9. An image outputting apparatus described in claim 8, wherein said image file is in a predetermined file format having an accompanying information storing area for storing shooting conditions, and shooting date and time of said image.

10. An image outputting program directing an image outputting apparatus to execute the following steps of:
loading thumbnail image data from an image file storing, as said image data, principal image data and said thumbnail image data having data size smaller than said principal image data;
producing an index image having plural thumbnail images arranged with the use of said thumbnail image data; and
outputting said index image.

11. An image outputting program described in claim 10, wherein said index image outputting step further including the steps of:
displaying said index image on a monitor;
selecting one of said thumbnail images from said index image displayed on said monitor;
loading said principal image data corresponding to the selected thumbnail image; and
printing a principal image reproduced from said principal image data on a first surface of a recording material and said index image on a second surface of said recording material.
